(19) United States
(12) Patent Application Publication
(10) Pub. No.: US 2022/0250718 A1
(43) Pub. Date: Aug. 11, 2022

(54) Portable Drink Holder for use in Fishing Rod Holder

(71) Applicant: Gary Allen Maier, Tomball, TX (US)

(72) Inventor: Gary Allen Maier, Tomball, TX (US)

(21) Appl. No.: 17/173,596

(22) Filed: Feb. 11, 2021

(51) Int. Cl. B63B 17/00; A01K 97/00

(52) U.S. Cl. CPC B63B 17/00; A01K 97/00

(57) ABSTRACT

A Drink holder inserted into a fishing boat's existing rod holders for the convenience of securely holding a variety of single drink container sizes and shapes while reducing the potential for spills which may lead to slips and falls causing personal injury.

The drink holder will fit inside various internal diameter boat rod holder's and adjust to their relative inclination ranging from 0 degrees being vertical, to 45 degrees from vertical while allowing a comfortable hands free fishing trip to grab a fishing rod, drink nearby, or handrail.

This invention simply converts a fishing rod holder into a drink holder.

### CROSS-REFERENCE TO RELATED APPLICATIONS “NOT APPLICABLE”

### BACKGROUND OF THE INVENTION

In lieu of a recent fishing trip onboard a boat which boasted over 20 fishing rod holders and only Two drink holders I thought up this simple invention to make my next trip more enjoyable.

I searched the market for existing product's which failed to hold a variety of different size tumblers and appear unstable while in use as they do not sit flush on the top of the fishing rod holder making them cumbersome onboard while others are limited to a vertical only or Thirty degree only and do not offer any lateral movement or securing features.

Another existing alternative is a combination gunwale rod holder and drink holder which requires an excessively large installation hole to be drilled in the gunwale compromising the integrity of the boats gunwale which may lead to fiberglass cracking or eventual breakage.

I therefor decided to design, and 3D print a prototype as shown in the figures and test fit it with various drinks and tumblers.
Prior Art-U.S. Pat. No. 7,004,102 B2

Existing Similar Product Links:

https://www.boatoutfitters.com/rod-holder-cup-holder

https://www.boatoutfitters.com/rod-and-cup-combo-fifteen-degree

https://www.toddusa.com/productdetails.aspx!id=5

### BRIEF SUMMARY OF THE INVENTION

The object of the invention is to add a drink holder to a boats Vertical fishing rod holder or easily adjust to fit inside an angular gunwale fishing rod holder without the use of any tools. Additionally, the drink holder will fit securely within a variety of different sized fishing rod holder as well as securely hold a variety of different sizes and configurations of drink containers.

Additionally, the drink holder will fit securely within a variety of different sized fishing rod holder as well as securely hold a variety of different sizes and configurations of drink containers.

### BRIEF DESCRIPTION OF THE SEVERAL VIEWS OF THE DRAWING

FIG. 1-Invention shown at the vertical position and poles outer groove for motion limiting device.

FIG. 2-Invention shown at the vertical position inside a vertical fishing rod holder with movement limiting device and cups upper half section.

FIG. 3-Invention shown at the Thirty degree angle position.

FIG. 4-Invention shown at the Thirty degree angle position inside a Thirty degree flush mount gunwale fishing rod holder and the cup receptacle general region to hold a drink container.

FIG. 5A-Invention internal profile location in upper half of the receptacle with a drink container.

FIG. 5B-Cup internal profile

FIG. 6-Invention pivotal hardware and flexible regions to limit tilting.

FIG. 7-Invention slot bottom view and ports

FIG. 8A-Invention detent features

FIG. 8B-Invention detent features

FIG. 9-Invention captivating nut or bolt pocket

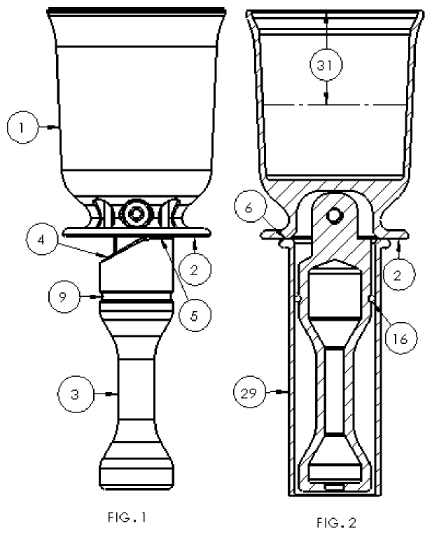

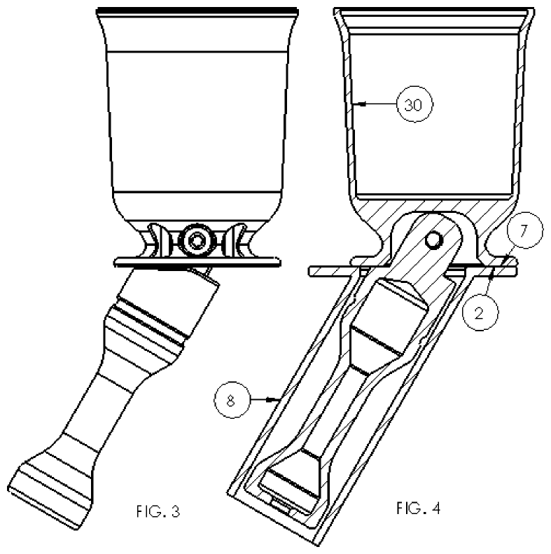

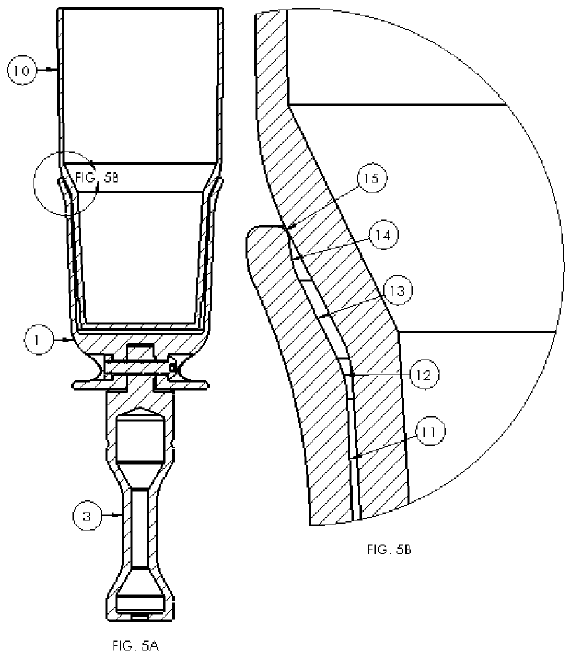

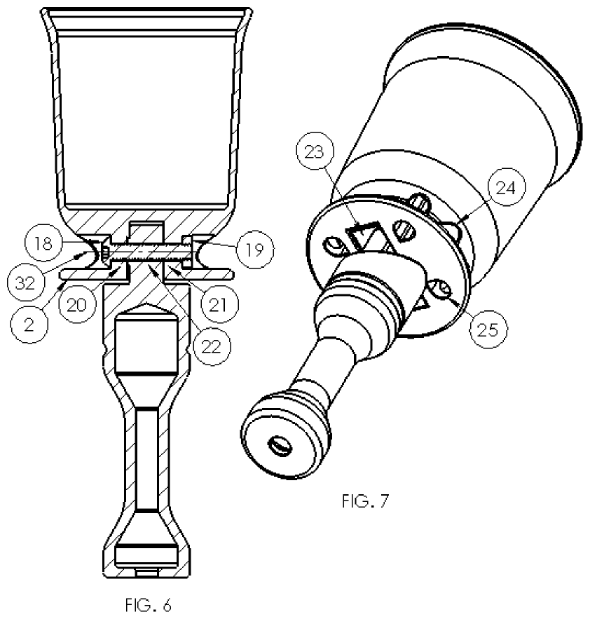

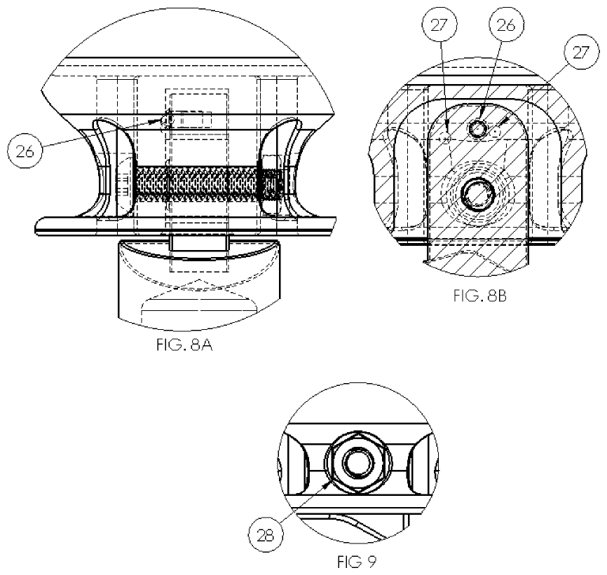

### DETAILED DESCRIPTION OF THE INVENTION

The invention is intended for portable use on fishing boats or boats which possess fishing rod holders and few drink holders relative to passengers.

Referring to the drawings, the cup 1 has a receptacle 30 to hold a drink container 10 whereas drink container refers to but not limited to a can, bottle, cup, glass, mug, or tumbler throughout this patent application.

The cup 1 is attached to the pole 3 by a threaded device being a bolt or screw 18 and a captivated nut 19 in an anti-rotation pocket 28 which is placed inside a vertical fishing rod holder 29 while the base of the cup 2 rests on top of the vertical rod holder flange 6 preventing further downward motion of the cup 1.

Similarly, on a Thirty degree angle fishing rod holder 8 the base of the cup 2 rests on top of the fishing rod holder flange 7 while preventing further downward motion of the cup 1.

The cup 1 and the pole 3 pivot around axis 32 located above the cups base 2 throughout a continuous range from Zero degrees being vertical to Thirty degrees from vertical.

Positive stops 4 and 5 on the pole 3 contact with the base of the cup 2 limiting relative tilting motion between the cup 1 and pole 3 while in the Vertical fishing rod holder 29 or a Thirty degree angle fishing rod holder 8 providing a secure position against external forces or impact.

The pole 3 consists of a groove 9 or plurality of grooves to accept a movement limiting device 16 in the form of an O-Ring, Elastomeric or Non-elastomeric device secured within the groove 9 to fit inside various internal diameter sizes of fishing rod holders 29 and 28.

The cup 1 receptacle 30 upper half 31 is comprised of a plurality of tapered bores 11 and 13 which are adjoined with radius's 12 and 14 and 15 creating a profile to securely hold a variety of sizes and shapes of drink containers 10 and centralize the drink container 10 within the cup receptacle 30.

A slot 23 within the base of the cup 1 accepts a mating flat section 22 on the pole 3 creating a contact area when the cup 1 slot bosses 20 and 21 are compressed by a threaded screw 18 and nut 19 creating friction to limit or lock pivotal tilting movement between the cup 1 and pole 3.

The contacting faces 20 including 21 and 22 may include an integral or independent multi-faceted locking washer to restrict pivotal movement relative to the cup 1 and pole 3.

A ball plunger or detent device 26 press fitted within the flat section 22 of the pole 3 snaps into a hole or mating concave surface on the side wall 20 of the cup 1 slot 23.

A plurality of holes or concave mating surfaces 27 are radially placed around the bolt 18 center axis in the side wall 20 of the cup 1 slot 23 to accept the spring loaded detent ball and locking the detent 26 in common Zero, Fifteen and Thirty degree positions.

1. The upper half of the drink holders cup receptacle contains an internal profile consisting of multiple internal diameters created by a plurality of entities consisting of tapered bores known as chamfers, cylindrical bores and curved radii known as filets.
Use of any combination consisting of Two or more entities of which may be a filet, chamfer or cylindrical bore for the purpose of centralizing a drink container within the upper half of the cup receptacle of a drink holder to restrict lateral movement of various sizes and shapes of drink containers.
Use of Two or more non-equal internal diameters within the upper half of the cup receptacle of a drink holder.

2. The pivotal tilting axis location of the cup and pole is above the base of the cup and is an integral feature of the cup.

3. The cup portion contains One or more slots within the bottom to accept the pole. An interference fit or flexible section of the cup or pole creates a contact area under compression by use of threaded hardware to limit or lock relative pivotal tilting movement between the cup and pole.

4. The cup and pole have mating contact points between them while straight in the vertical position or tilted at the maximum pivot angle creating Two positive stop positions.

5. Multiple Pivotal tilting angles between the cup and pole may be selectively positioned by use of a ball plunger detent, an integral or independent multi-faceted lock washer surrounding the bolt hole faces on the cup and pole to restrict pivotal tilting between the cup and pole.

6. The poles outer diameter has an external groove or multiple grooves to contain an elastomeric or non-elastomeric movement limiting device including O-Rings to reduce vibration or lateral movement and secure the pole inside the fishing rod holder to accommodate varying internal diameters of different fishing rod holders.
